(19) United States
(12) Patent Application Publication
(10) Pub. No.: US 2025/0178636 A1
(43) Pub. Date: Jun. 5, 2025

(54) METHOD AND SYSTEM FOR ONLINE MODEL PREDICTIVE PLANNING BASED ON LEARNING IDENTIFICATION AND CLASSIFICATION OF CONSTRAINT

(71) Applicant: Korea Advanced Institute of Science and Technology, Daejeon (KR)

(72) Inventors: Dongsuk KUM, Daejeon (KR); Abi Rahman SYAMIL, Daejeon (KR); Hanbin JANG, Daejeon (KR)

(73) Assignee: Korea Advanced Institute of Science and Technology, Daejeon (KR)

(21) Appl. No.: 18/952,506

(22) Filed: Nov. 19, 2024

(30) Foreign Application Priority Data
Nov. 30, 2023 (KR) 10-2023-0171336

(51) Int. Cl. B60W 60/00

(52) U.S. Cl. CPC B60W 60/001; B60W 2554/802

(57) ABSTRACT

Disclosed is a method and system for real-time model predictive control-based planning of an autonomous vehicle based on identification and classification learning of constraints. A real-time model predictive control-based planning method may include generating a class prediction decision value that determines an upper bound and a lower bound of constraints in an optimal control problem through an observation value for a driving environment; and receiving the class prediction decision value and the observation value from the driving environment and generating a main trajectory.

### CROSS-REFERENCE TO RELATED APPLICATION

This application claims the priority benefit of Korean Patent Application No. 10-2023-0171336, filed on Nov. 30, 2023, in the Korean Intellectual Property Office, the disclosure of which is incorporated herein by reference.

### BACKGROUND

### 1. Field of the Invention

Example embodiments of the following description relate to a method and system for real-time model predictive control-based planning of an autonomous vehicle based on identification and classification learning of constraints.

### 2. Related Art

A decision-and-planning module in autonomous driving software is an algorithm that needs to plan a trajectory and a speed for safe and efficient driving even in very diverse and complex situations. However, it is very difficult to ensure the optimal driving performance through this algorithm.

The decision-and-planning module may be largely categorized into 1) a rule-based system, 2) an optimization-based planning system, and 3) a learning-based planning system.

The rule-based planning system is intuitively applicable, interpretable, and efficient due to a less computational amount. However, it is difficult to define a rule capable of handling all situations and incontrollable for a situation deviated from a designed rule.

The optimization-based planning system may find an optimal trajectory that achieves constraints and ensures stability for various situations. However, the optimization-based planning system needs to solve optimization problems repeatedly, which leads to increasing a computational amount and difficulty in real-time application.

The learning-based planning system may be applied to complex driving environments by mapping cognitive information of a surrounding environment to necessary information through a deep learning network. Since parallel processing is possible, real-time performance is good, but learning about various situations is difficult. Also, it is difficult to interpret and modify meaning of an algorithm, and the stability of output may not be guaranteed.

Reference material includes Korean Patent Registration No. 10-2053071.

### SUMMARY

Example embodiments provide a method and system for real-time model predictive control-based planning of an autonomous vehicle based on identification and classification learning of constraints.

According to an example embodiment, there is provided a real-time model predictive control-based planning method of a computer device including at least one processor, the method including generating, by the at least one processor, a class prediction decision value that determines an upper bound and a lower bound of constraints in an optimal control problem through an observation value for a driving environment; and receiving, by the at least one processor, the class prediction decision value and the observation value from the driving environment and generating a main trajectory.

According to an aspect, the class prediction decision value may include a value for identifying a surrounding object in the driving environment and classifying the same into a plurality of levels including the upper bound and the lower bound to determine whether an ego vehicle gives way to the surrounding object or passes before the surrounding object.

According to another aspect, the upper bound may include an upper bound of longitudinal distance constraints, the lower bound may include a lower bound of longitudinal distance constraints, and the plurality of levels may further include ignore that does not need to be considered for constraints.

According to still another aspect, the generating of the class prediction decision value may include generating the class prediction decision value by identifying and classifying the surrounding object into one of the plurality of levels and by simplifying a problem through convexification of non-convex constraints of model predictive control-based planning into convex constraints.

According to still another aspect, the generating of the class prediction decision value may include generating the class prediction decision value by identifying and classifying a surrounding object in the driving environment using a trained deep learning network, in order to provide a high level decision maker function.

According to still another aspect, the deep learning network may be trained through deep reinforcement learning based on a state for an ego vehicle and the surrounding object, an action of identifying and classifying a class based on the state, and a reward generated based on results of the action.

According to still another aspect, longitudinal constraints of convex nature of model predictive control-based planning may be determined through class identification and classification that is the action, a trajectory may be generated based on the longitudinal constraints through the model predictive control-based planning, and the reward for at least one of success, collision, failure, and driving performance of the generated trajectory may be computed through evaluation for the generated trajectory.

According to still another aspect, the deep learning network may be trained through supervised machine learning using a dataset generated by search-based model predictive control-based planning, the search-based model predictive control-based planning may generate a trajectory using a state transmitted from a simulator for an arbitrary driving environment, may generate classification data by identifying and classifying classes of surrounding objects based on the generated trajectory, and may store the classification data in the dataset

According to still another aspect, the search-based model predictive control-based planning may combine an A* algorithm with model predictive control-based planning, the A* algorithm may support MPP(Model Predictive Planning) convergence and may enable convexification.

According to still another aspect, the deep learning network may be trained using the classification data as ground truth.

According to still another aspect, the deep learning network may be trained through a random batch of the dataset.

According to still another aspect, the search-based model predictive control-based planning may set constraints by generating the trajectory and identifying and classifying the surrounding object through a heuristic method.

According to still another aspect, the generating of the main trajectory may include generating the main trajectory using model predictive control-based planning among optimization-based planning methods.

According to still another aspect, the real-time model predictive control-based method may further include generating, by the at least one processor, a contingency trajectory through the observation value for the driving environment.

According to still another aspect, the real-time model predictive control-based method may further include determining, by the at least one processor, one of the main trajectory and the contingency trajectory as a final trajectory.

According to an example embodiment, there is provided a computer program stored in a computer-readable recording medium to execute the method on a computer device in conjunction with the computer device.

According to an example embodiment, there is provided a non-transitory computer-readable recording medium storing a program to execute the method on a computer device.

According to an example embodiment, there is provided a computer device including at least one processor configured to execute computer-readable instructions, wherein the at least one processor causes the computer device to generate a class prediction decision value that determines an upper bound and a lower bound of constraints in an optimal control problem through an observation value for a driving environment, and to receive the class prediction decision value and the observation value from the driving environment and generate a main trajectory.

According to some example embodiments, it is possible to provide a method and system for real-time model predictive control-based planning of an autonomous vehicle based on identification and classification learning of constraints.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of a structure of a real-time model predictive control-based planning system according to an example embodiment;

FIG. 2 illustrates an example of a process of identifying and classifying constraints according to an example embodiment;

FIG. 3 illustrates an example of a learning process for deep reinforcement learning according to an example embodiment;

FIG. 4 illustrates an example of an action of deep reinforcement learning according to an example embodiment;

FIG. 5 illustrates an example of a learning process for a supervised machine learning method according to an example embodiment;

FIG. 6 illustrates an example of the overall structure of an algorithm to which a contingency planner is added according to an example embodiment;

FIG. 7 is a block diagram illustrating an example of a computer device according to an example embodiment;

FIG. 8 is a flowchart illustrating an example of a learning and model predictive control-based planning method according to an example embodiment;

FIG. 9 illustrates an example of a non-signalized intersection scenario according to an example embodiment;

FIGS. 10 to 13 are graphs showing examples of experimental results;

FIG. 14 is a graph showing evaluation results for effectiveness of a contingency planner according to an example embodiment; and

FIGS. 15 and 16 are graphs showing qualitative results by visualizing an identification and classification method of constraints according to an example embodiment.

### DETAILED DESCRIPTION

Hereinafter, example embodiments will be described in detail with reference to the accompanying drawings.

Example embodiments may provide trajectory planning technology that is robust in a dynamic driving environment, enables a real-time operation, and is applicable to any road. In the case of Advanced Driver Assistance Systems (ADAS) that are currently commercialized, a rule-based planning system is applied. It operates only within established rules and has a limited operational domain design (ODD), which limits generalization and performance improvement. To solve this, optimization-based planning technologies are being researched and one of them, model predictive control-based planning technology has an advantage of being able to find an optimal trajectory while satisfying many constraints in a complex driving environment.

However, due to non-convex constraints of an optimization problem, a local optimal solution convergence problem and a real-time performance problem may occur during optimization. There is a probability that a non-convex problem may fall into a local optimal solution. This local optimal solution may not be globally optimal and may differ from an actual optimal trajectory. Also, the non-convex problem requires a large computational amount during optimization, making it impossible to secure real-time performance of model predictive control-based planning. Therefore, to apply optimization-based planning technology to autonomous driving, the local optimal solution convergence problem and the real-time performance problem caused by non-convex constraints need to be solved.

Accordingly, the example embodiments may provide longitudinal trajectory planning technology that may solve a local optimal solution convergence problem and a real-time performance problem and may generate an optimal trajectory in real time by convexifying non-convex constraints of an optimization problem into convex constraints through a learning-based method to simplify the optimization problem into a quadradic programming problem.

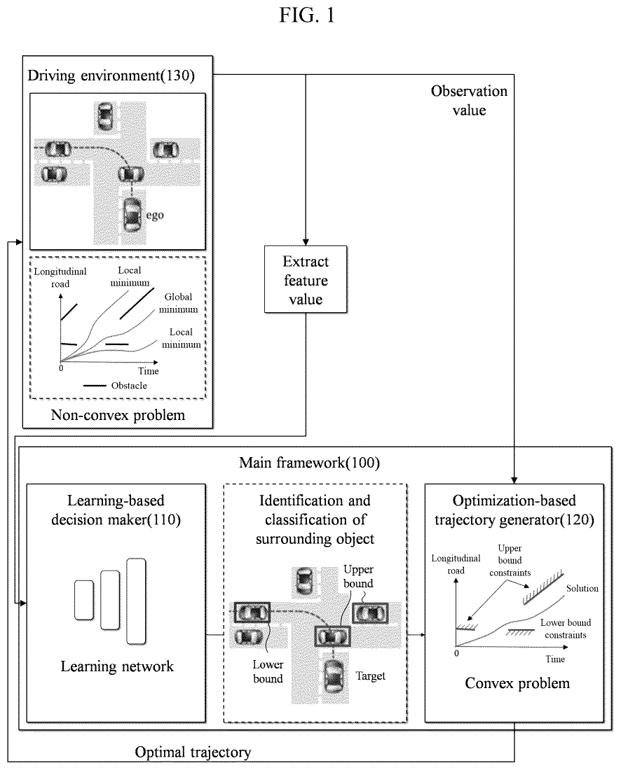

FIG. 1 illustrates an example of a structure of a real-time model predictive control-based planning system according to an example embodiment. A main framework 100 for the real-time model predictive control-based planning system according to the example embodiment of FIG. 1 may include a learning-based decision maker 110 and an optimization-based low level trajectory generator 120.

The learning-based decision maker 110 may receive information (e.g., observation value for driving environment 130) from the driving environment 130 and may identify and classify a surrounding object. This learning-based decision maker 110 may serve as a high level decision maker by simplifying an existing trajectory generation problem through an identification and classification process. Here, an object may refer to an object that may appear around an ego vehicle in the driving environment 130, such as a vehicle, a bicycle, and a person.

The optimization-based low level trajectory generator 120 may serve as a low level trajectory generator of receiving a class prediction decision value from the learning-based decision maker 110 that serves as the high level decision maker and receiving an observation value from the driving environment 130 and generating an optimal trajectory. This optimization-based low level trajectory generator 120 may generate an optimal trajectory using a model predictive control-based planning method among optimization-based planning methods.

In more detail, the learning-based decision maker 110 may identify and classify a surround object into one of “upper bound,” “lower bound,” and “ignore.” Through this classification, the learning-based decision maker 110 may serve as the high level decision maker that reduces a search space by determining whether the ego vehicle gives way to the surrounding object or passes before the surrounding object.

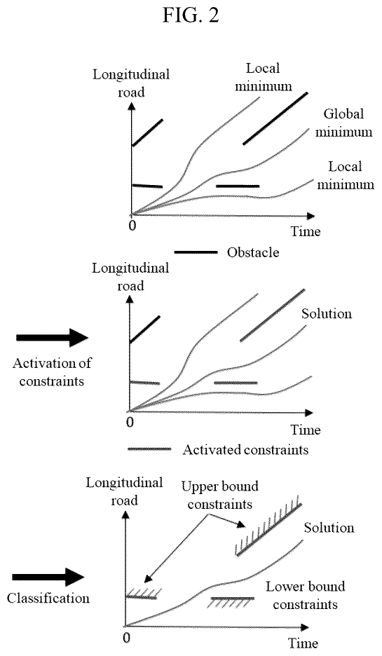

FIG. 2 illustrates an example of a process of identifying and classifying constraints according to an example embodiment. As described above, the learning-based decision maker 110 may serve to identify and classify a surround object into one of “upper bound,” “lower bound,” and “ignore.” Here, identification and classification of the surrounding object may perform the role of convexifying non-convex constraints used for predictive control-based planning into convex constraints. In Equation 1 below, a left term may represent non-convex constraints in which a longitudinal distance is set to be greater than a preset safety distance and a right term may represent convex constraints as inequality based upper and lower bound conditions.

$$\vert {s}^{n} ( t ) - {s}^{ego} ( t ) \vert \geq {d}_{safety} , ∀ n \neq ego \to {s}_{min} ( t ) \leq {s}^{ego} ( t ) \leq {s}_{max} ( t ) \qquad [ Equation 1 ]$$

$${s}^{ego} ( t ) : Longitudinal location of own vehicle$$

$${s}^{n} ( t ) : Longitudinal location of another object$$

$${d}_{safety} : Safety distance$$

$${s}_{min} ( t ) : Lower bound constraints$$

$${s}_{max} ( t ) : Upper bound constraints$$

An object classified into “upper bound” may be set to the upper bound of longitudinal distance constraints, and an object classified into “lower bound” may be set to the lower bound of longitudinal distance constraints. Also, an object classified into “ignore” may represent a classification that does not need to be considered for constraints.

The learning-based decision maker 110 may simplify a non-convex optimization problem into a quadratic programming problem by convexifying non-convex constraints of the driving environment 130 into convex constraints through a process of identifying and classifying a surrounding object. This learning-based decision maker 110 may solve a local optimal solution convergence problem of non-convex constraints and, at the same time, may solve a real-time operation problem by significantly reducing a computational amount required during optimization.

To implement this learning-based decision maker 110, a deep learning network may be used. As an example embodiment, a learning framework for the learning-based decision maker 110 may be implemented through two methods, a deep reinforcement learning method and a supervised machine learning method.

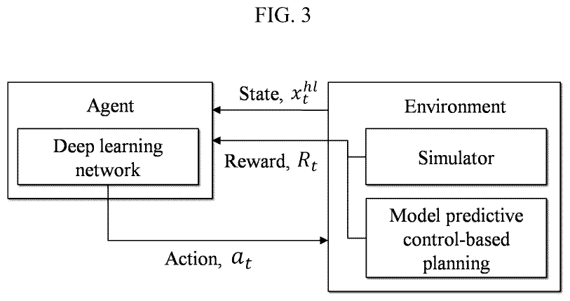

FIG. 3 illustrates an example of a learning process for deep reinforcement learning according to an example embodiment. The example embodiment of FIG. 3 represents a learning framework of deep reinforcement learning. Here, a state may represent a state for an ego vehicle and a surrounding object, and an action may represent identifying and classifying a class for each object. Also, a reward may represent a reward for success, collision, failure, and driving performance of a generated trajectory.

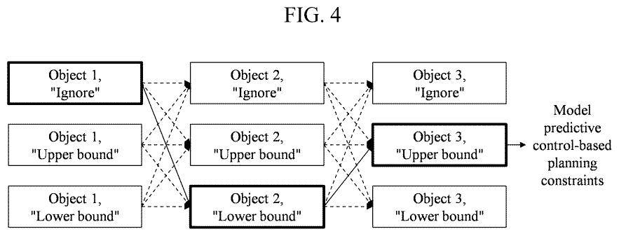

FIG. 4 illustrates an example of an action of deep reinforcement learning according to an example embodiment. An agent for performing deep reinforcement learning may perform an action of receiving a state from an environment and identifying and classifying a class of an object. The action may determine longitudinal constraints on convex nature of model predictive control-based planning, and the model predictive control-based planning may generate a trajectory based on the determined longitudinal constraints.

Meanwhile, a reward may be computed as Equation 2 below through evaluation for the generated trajectory.

$${R}_{success} = {r}_{success} ( constant ) \qquad [ Equation 2 ]$$

$${R}_{crash} = {r}_{crash} ( constant )$$

$${R}_{no solution} = {r}_{no solution} ( constant )$$

$${R}_{step cost} = {w}_{{R}_{1}} ( K - {\sum }_{k = 1}^{K} min ( J ( {x}_{t + k} , {u}_{t + k - 1}^{*} ) , {w}_{{R}_{2}} ) / {w}_{{R}_{2}} ) ∼ ( 0 , {w}_{{R}_{1}} K )$$

$${R}_{success} : Reward for passing intersection without crash$$

$${R}_{crash} : Reward for crash$$

$${R}_{no solution} : Reward for finding no solution$$

$${R}_{step cost} : Reward for trajectory performance$$

$${w}_{{R}_{1} ,} {w}_{{R}_{2}} : Positive weight$$

$$K = \frac{Δ {t}_{hl}}{Δ {t}_{sim}} , Δ {t}_{hl} : Operation cycle for high level decision maker$$

$$Δ {t}_{sim} : Operation cycle for simulation$$

$${v}_{ref , k} : Speed reference value$$

$${u}_{k} : Input acceleration$$

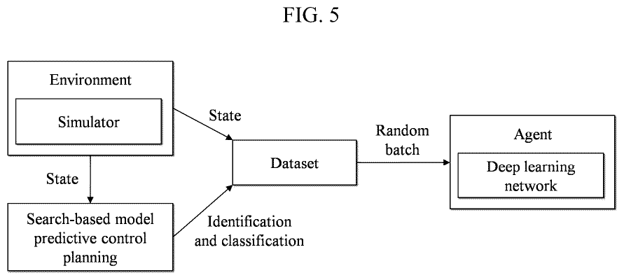

FIG. 5 illustrates an example of a learning process for a supervised machine learning method according to an example embodiment. The example embodiment of FIG. 5 represents a learning framework of supervised machine learning. An optimal trajectory may be generated from a simulator by a search-based model predictive control-based planning. Afterwards, the search-based model predictive control-based planning may identify and classify surrounding objects into “upper bound,” “lower bound,” and “ignore” through Equation 3 and Equation 4 below based on the generated trajectory, may generate classification data, and then may store the classification data in a dataset.

$${s}_{max , k} = min ( {s}_{k}^{n} - {s}_{k} ) , ∀ n \neq ego \qquad [ Equation 3 ]$$

$${s}_{min , k} = max ( {s}_{k} - {s}_{k}^{n} ) , ∀ n \neq ego \qquad [ Equation 4 ]$$

Equation 3 may represent upper bound reference condition and Equation 4 may represent lower bound reference condition. Here, s_{max,k}(t) may denote an upper bound constraint reference point, s_{min,k}(t) may denote a lower bound constraint reference point, sₖ may denote a longitudinal location of an ego vehicle, sₖⁿ may denote a longitudinal location of another object, and d_{safety} may denote a safety distance.

Meanwhile, class classification of surrounding objects may be used as ground truth of deep learning network learning. The stored dataset may be used to train a deep learning network through random batch.

The search-based model predictive control-based planning refers to a trajectory planning method that fuses a heuristic method and model predictive control-based planning and may be used to generate ground truth data of the deep learning network. For example, the search-based model predictive control-based planning may establish optimization constraints by generating a trajectory and identifying and classifying the surrounding object through the heuristic method, and may generate a final optimal trajectory through the model predictive control-based planning method.

As described above, the optimization-based low level trajectory generator 120 may generate the final trajectory using model predictive control-based planning that is one of optimization-based planning methods and an objective function and constraints for generating the optimal trajectory are shown in Equation 5 below.

$$[ Equation 5 ]$$

$$( Objective function ) {min}_{{U}_{t}} {\sum }_{k = 1}^{H} {{{w}_{1} ( {v}_{ref , t + k} - {v}_{t + k} )}^{2}}_{( Speed tracking performance )} + {{w}_{2} {u}_{k - 1}^{2}}_{( Acceleration input value )} \begin{matrix}{U}_{t} \text{?} [ u \text{?} , … , {u}_{t + H - 1} ] & : & Acceleration\end{matrix}$$

$$Subject to :$$

$$H : Planning hours$$

$$( Dynamic constraints ) \underbrace{[ \begin{matrix}{s}_{t + k + 1} \\ {v}_{t + k + 1}\end{matrix} ]}_{{x}_{t + k + 1}} = [ \begin{matrix}1 & Δ \text{?} \\ 0 & 1\end{matrix} ] \underbrace{[ \begin{matrix}{s}_{t + k} \\ {v}_{t + k}\end{matrix} ]}_{{x}_{t + k}} + [ \begin{matrix}\frac{1}{2} Δ {t}^{2} \\ Δ t\end{matrix} ] {u}_{t + k}$$

$${w}_{1} \& {w}_{2} : Weight$$

$${v}_{ref} : Speed reference value$$

$$\begin{matrix}\begin{matrix}\begin{matrix}( Initial condition ) & {x}_{t} = x ( t )\end{matrix} & v :\end{matrix} & Speed\end{matrix}$$

$$s : Longitudinal location$$

$$\begin{matrix}( Control constraints ) & {u}_{t + k , min} \leq {u}_{t + k} \leq {u}_{t + k , max}\end{matrix}$$

$${s}_{min} : Longitudinal lower bound value$$

$$( Speed constraints ) 0 \leq {v}_{k} \leq {v}_{t + k , max}$$

$${s}_{max} : Longitudinal upper bound value$$

$$\begin{matrix}( Longitudinal & \begin{matrix}{s}_{t + k , min} \leq {s}_{k} \leq {s}_{t + k , max}\end{matrix} \\ stability constraints ) & \end{matrix} \begin{matrix}Convex constraints \\ generated by learning - \\ based decision maker\end{matrix}$$

$$Δ t \text{?} : 0.2 seconds$$

$$Δ t : 0.1 second$$

$$\text{?} \text{indicates text missing or illegible when filed}$$

The objective function considers tracking performance and comfort for target speed and constraints may include dynamic constraints, initial condition, control constraints, speed constraints, and longitudinal stability constraints. Also, constraints on convex nature generated by the learning-based decision maker 110 may be generated.

An optimization problem may be simplified into a quadratic programming problem by convexifying constraints using the learning-based decision maker 110. The simplified optimization problem may generate an optimal trajectory using a quadratic programming solver such as an Interior Point OPTimizer (IPOPT) solver.

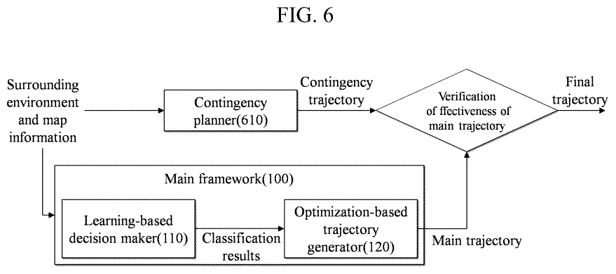

FIG. 6 illustrates an example of the overall structure of an algorithm to which a contingency planner is added according to an example embodiment. The contingency planner may serve to generate a trajectory that ensures stability when a solution trajectory is not found in a main framework or when a generated trajectory violates a safety standard. That is, the contingency planner may be used as a backup system of a main trajectory. The contingency planner may operate in parallel with the main framework and may generate a trajectory by modifying an objective function and constraints as shown in Equation 6 below, such that a vehicle may stop.

$$( Objective function ) {{min}_{U \text{?}} {\sum }_{k = 1}^{H} {w}_{1} {v}_{k}^{2} + {w}_{2} {u}_{k - 1}^{2}}_{( Speed and acceleration minimization )} \qquad [ Equation 6 ]$$

$$subject to :$$

$$\begin{matrix} & u\end{matrix} \qquad : Acceleration$$

$$\begin{matrix}\begin{matrix}( Dynamic constraints ) & {x}_{t + k + 1} = {Ax}_{t + k} + {Bu}_{t + k}\end{matrix} & H\end{matrix} \qquad : Planning hours$$

$$( Initial condition ) \qquad {x}_{t} = x ( t ) \qquad {w}_{1} \& {w}_{2} \qquad : Weight$$

$$( Control constraints ) \qquad {u}_{min , t + k} \leq {u}_{t + k} \leq {u}_{max , t + k} \qquad v \qquad : Speed$$

$$( Speed constraints ) \qquad {v}_{min , k} \leq {v}_{k}$$

$$\text{?} \text{indicates text missing or illegible when filed}$$

As such, according to example embodiments, a local optimal solution problem and a real-time operation problem of an optimization problem may be simultaneously solved. In example embodiments, it is possible to reduce a computational amount of optimization-based planning technology by simplifying non-convex constraints of an optimization-based method into convex constraints through a learning-based identification and classification process. Through this, in example embodiments, since it is possible to perform a real-time operation and to find a global optimal solution, an optimal trajectory that solves a local optimal solution convergence problem may be generated.

Also, example embodiments may provide a longitudinal speed control algorithm that may be applied to any road, such as a non-signalized road, a circular intersection, and a merge road. An identification and classification method of constraints according to an example embodiment may generate an optimization-based longitudinal speed trajectory in real time for all cases in which a trajectory to proceed is determined. Therefore, the identification and classification method of constraints may be applied to any road and may be universally applied to various autonomous driving decision and planning fields.

Also, example embodiment may visualize output of a deep learning network as shown in FIG. 2. Therefore, it is possible to increase interpretability of the deep learning network.

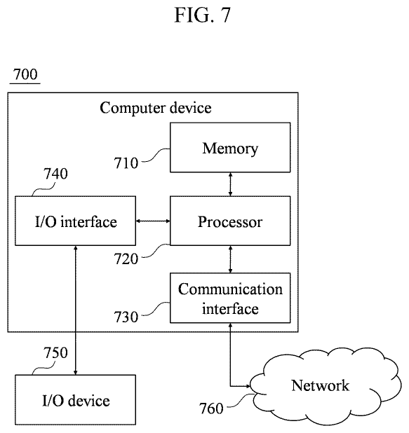

FIG. 7 is a block diagram illustrating an example of a computer device according to an example embodiment. Referring to FIG. 7, the computer device 700 may include a memory 710, a processor 720, a communication interface 730, and an input/output (I/O) interface 740. The memory 710 may include, as computer-readable recording media, a permanent mass storage device such as random access memory (RAM), read only memory (ROM), and disk drive. Here, the permanent mass storage device, such as ROM and disk drive, may be included in the computer device 700 as a separate permanent storage device from the memory 710. Also, an operating system (OS) and at least one program code may be stored in the memory 710. Such software components may be loaded to the memory 710 from computer-readable recording media separate from the memory 710. Examples of the separate computer-readable recording media may include computer-readable recording media, such as a floppy drive, a disk, a tape, a DVD/CD-ROM drive, and a memory card. In another example embodiment, software components may be loaded to the memory 710 through the communication interface 730, rather than the computer-readable recording media. For example, the software components may be loaded to the memory 710 of the computer device 700 based on a computer program installed by files received through a network 760.

The processor 720 may be configured to process an instruction of a computer program by performing basic arithmetic, logic, and I/O operations. The instruction may be provided from the memory 710 or the communication interface 730 to the processor 720. For example, the processor 720 may be configured to execute the received instruction according to a program code stored in a storage device, such as the memory 710.

The communication interface 730 may provide a function for communication between the computer device 700 and another apparatus through the network 760. For example, a request or an instruction created by the processor 720 of the computer device 700 according to a program code stored in a storage device such as the memory 710, data, and a file may be delivered to other apparatuses over the network 760 under control of the communication interface 730. Inversely, a signal or an instruction, data, and a file from another apparatus may be received at the computer device 700 through the communication 730 of the computer device 700 over the network 760. The received signal or instruction and data may be delivered to the processor 720 or the memory 710 through the communication interface 730 and the file may be stored in a storage medium (the aforementioned permanent storage device) further includable in the computer device 700.

The I/O interface 740 may be a device for interfacing with an I/O device 750. For example, an input device may include a device, such as a microphone, a keyboard, and a mouse, and an output device my include a device, such as a display and a speaker. As another example, the I/O interface 740 may be a device for interfacing with a device in which an input function and an output function are integrated into a single function, such as a touchscreen. The I/O device 750 may be configured as a single device with the computer device 700.

Also, in other example embodiments, the computer device 700 may include a greater or smaller number of components than the number of components shown in FIG. 7. However, there is no need to clearly illustrate many conventional components. For example, the computer device 700 may be implemented to include at least a portion of the I/O device 750 or may further include other components, such as a transceiver and a database.

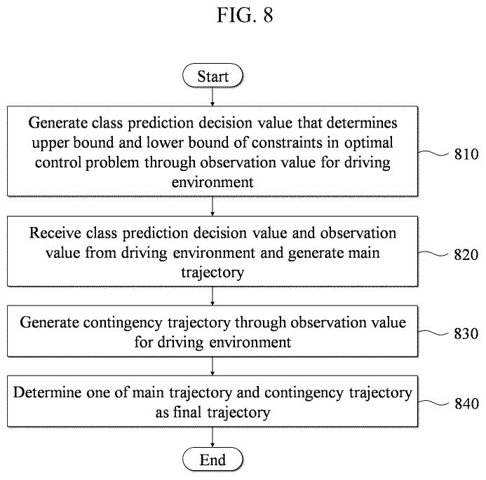

FIG. 8 is a flowchart illustrating a real-time model predictive control-based planning method according to an example embodiment. The real-time model predictive control-based planning method according to the example embodiment of FIG. 8 may be performed by the computer device 700 of FIG. 7. Here, the processor 720 of the computer device 700 may be implemented to execute a control instruction according to a code of at least one computer program or a code of an OS included in the memory 710. Here, the processor 720 may control the computer device 700 to perform operations 810 to 840 included in the method of FIG. 8 according to a control instruction provided from a code stored in the computer device 700. For example, the computer device 700 may be included in an ego vehicle and implemented to perform the real-time model predictive control-based planning method, but is not limited thereto.

In operation 810, the computer device 700 may generate a class prediction decision value that determines an upper bound and a lower bound of constraints in an optimal control problem through an observation value for a driving environment. Here, the class prediction decision value may include a value for identifying a surrounding object in the driving environment and classifying the same into a plurality of levels including the upper bound and the lower bound to determine whether an ego vehicle gives way to the surrounding object or passes before the surrounding object. The learning-based decision maker 110 for generating the class prediction decision value is described above. This learning-based decision maker 110 may be a functional expression of the processor 720 for controlling the computer device 700 to generate the class prediction decision value. For example, the computer device 700 may convexify non-convex constraints into convex constraints by identifying and classifying a surrounding object into one of a plurality of levels. Here, as described above, the plurality of levels may include an upper bound of longitudinal distance constraints, a lower bound of longitudinal distance constraints, and ignore that does not need to be considered for constraints.

Also, to provide a high level decision maker function in operation 810, the computer device 700 may generate the class prediction decision value by identifying and classifying a surrounding object using a trained deep learning network.

Here, the deep learning network may be trained through deep reinforcement learning based on states of an ego vehicle and the surrounding object, an action of identifying and classifying a class based on the state, and a reward generated based on results of the action. Here, longitudinal constraints of convex nature of model predictive control-based planning may be determined through class identification and classification that is the action, and a trajectory may be generated based on the longitudinal constraints through the model predictive control-based planning. Also, the reward for at least one of success, collision, failure, and driving performance of the generated trajectory may be computed through evaluation for the generated trajectory.

Also, a search-based model predictive control-based planning may generate a trajectory using a state transmitted from a simulator for an arbitrary driving environment, may generate classification data by identifying and classifying classes of surrounding objects based on the generated trajectory, and may store the classification data in the dataset. The deep learning network may be trained through supervised machine learning using the dataset generated by the search-based model predictive control-based planning. The search-based model predictive control-based planning may combine an A* algorithm with model predictive control-based planning. The A* algorithm may support MPP(Model Predictive Planning) convergence and may enable convexification In this case, the deep learning network may be trained using the classification data as ground truth. Also, the deep learning network may be trained through random batch of the dataset. Also, the search-based model predictive control-based planning may set constraints by generating the trajectory and identifying and classifying the surrounding object through a heuristic method.

In operation 820, the computer device 700 may receive the class prediction decision value and the observation value from the driving environment and may generate a main trajectory. The optimization-based low level trajectory generator 120 for generating the main trajectory is described above in detail. This optimization-based low level trajectory generator 120 may be a functional expression of the processor 720 for controlling the computer device 700 to generate the main trajectory. For example, the computer device 700 may generate the main trajectory using model predictive control-based planning among optimization-based planning methods.

In operation 830, the computer device 700 may generate a contingency trajectory through the observation value for the driving environment. The contingency planner of generating the contingency trajectory that ensures stability when a solution trajectory is not found in the main framework 100 or when a generated trajectory violates a safety standard is described above.

In operation 840, the computer device 700 may determine one of the main trajectory and the contingency trajectory as a final trajectory. For example, the computer device 700 may select one of the main trajectory and the contingency trajectory as the final trajectory depending on a stability status of the main trajectory.

To verify effectiveness for example embodiments, the example embodiments was implemented and proved a method of identifying and classifying constraints for trajectory planning in a Simulation of Urban Mobility (SUMO) simulator.

The surrounding object was selected as a vehicle and a Krauss driver model was applied to a surrounding vehicle, and the surrounding vehicle was configured not to avoid collision when a collision with an experimental vehicle was expected. By randomly designating a reaction time and a reaction time of a driver model of the surrounding vehicle through normal distribution to secure the diversity of traffic, generality and diversity of the experimental environment were secured.

To evaluate the performance of identification and classification method of constraints according to example embodiments, a rule-based method using a time to collision and a method in which A* algorithm and model predictive control-based planning are fused are set as the baseline.

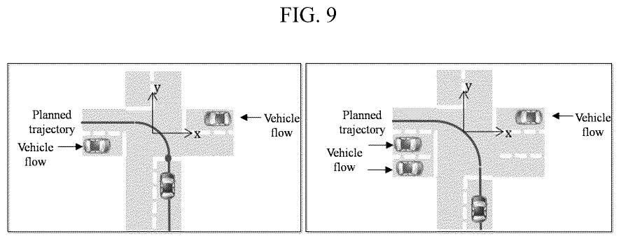

FIG. 9 illustrates an example of a non-signalized intersection scenario according to an example embodiment. The experiment and the evaluation are conducted in the non-signalized intersection scenario in which appropriate decision and operation planning is difficult among urban roads. In FIG. 9, a view on the left represents a non-signalized intersection with one lane and a view on the right represents a non-signalized intersection with two lanes.

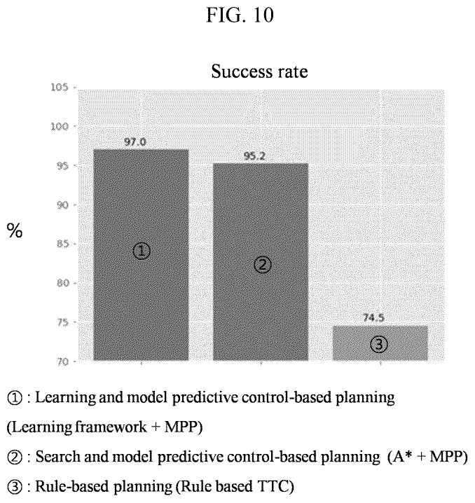

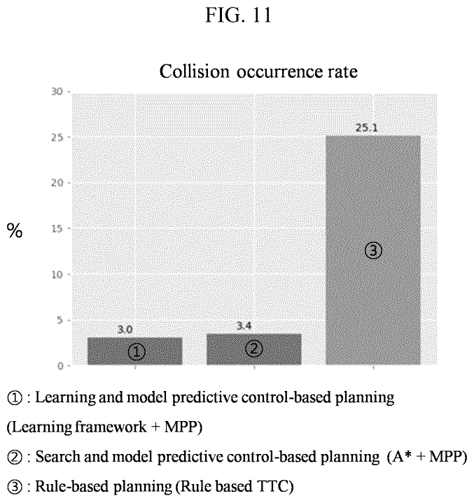

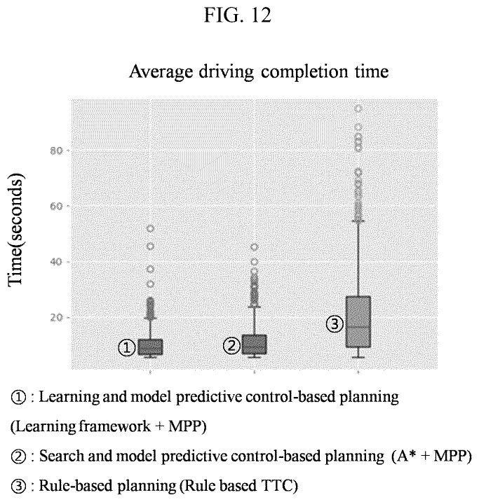

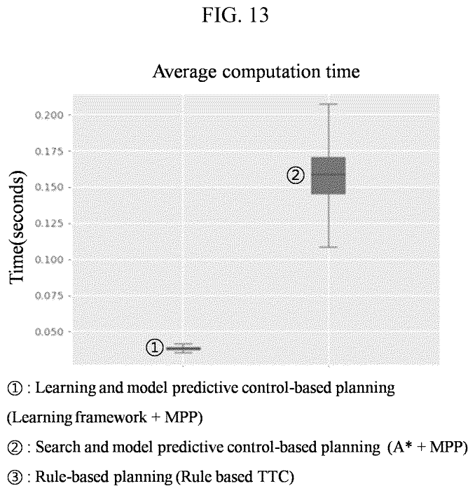

FIGS. 10 to 13 are graphs showing examples of experimental results. The graph shown in FIG. 10 is a graph that compares the performance of a real-time model predictive control-based planning method according to an example embodiment and the baseline in terms of a success rate, the graph shown in FIG. 11 is a graph that compares the performance of the real-time model predictive control-based planning method according to an example embodiment and the baseline in terms of a collision occurrence rate, the graph shown in FIG. 12 is a graph that compares the performance of the real-time model predictive control-based planning method according to an example embodiment and the baseline in terms of an average driving completion time, and the graph shown in FIG. 13 is a graph that compares the performance of the real-time model predictive control-based planning method according to an example embodiment and the baseline in terms of an average computation time. Through graphs of FIGS. 10 to 13, it can be seen that the real-time model predictive control-based planning method according to an example embodiment achieves a low computational amount and, at the same time, achieves a high success rate, a low collision occurrence rate, and a fast driving completion time.

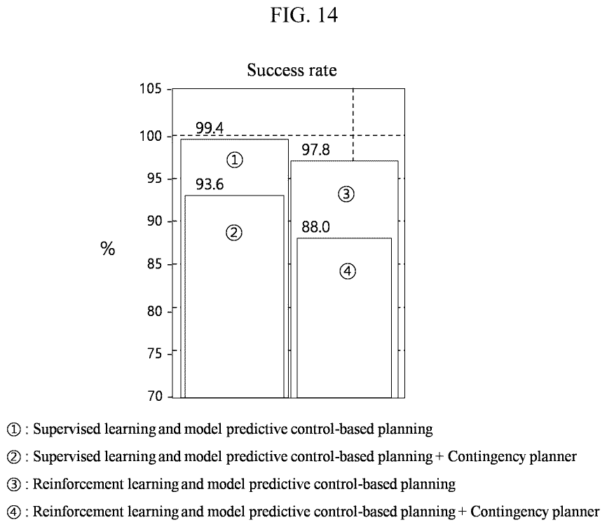

FIG. 14 is a graph showing evaluation results for effectiveness of a contingency planner according to an example embodiment. Through results of FIG. 14, it can be seen that a success rate increases using the contingency planner and, through this, effectiveness of the contingency planner is verified.

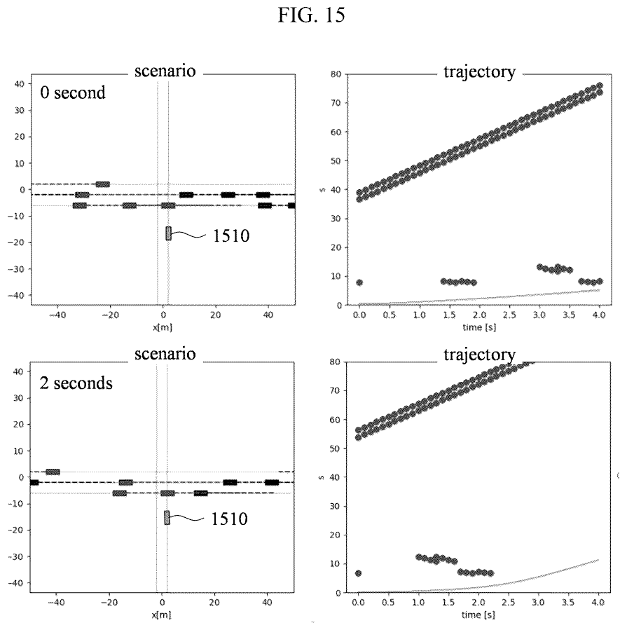

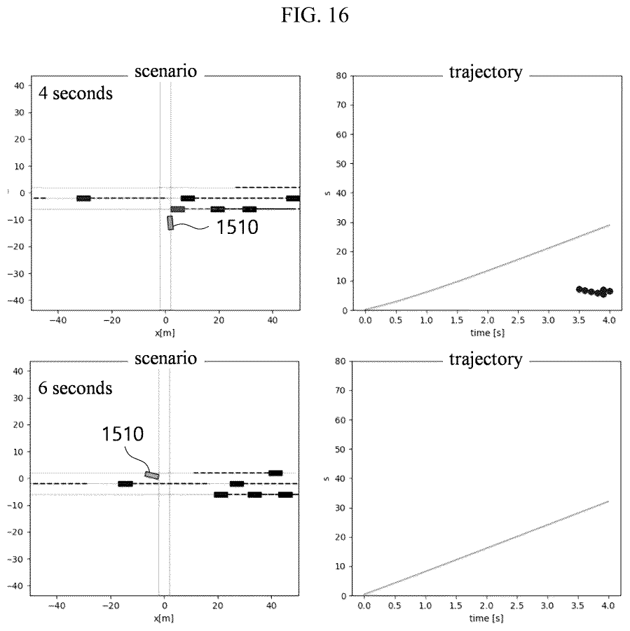

FIGS. 15 and 16 are graphs showing qualitative results by visualizing an identification and classification method of constraints according to an example embodiment. An ego vehicle (1510) may classify surrounding vehicles into upper bound, lower bound, and ignore, and may generate an optimal trajectory suitable for classification. It can be seen that the ego vehicle follows an optimal trajectory and safely passes the intersection, giving way to an upper bound vehicle before a lower bound vehicle passes.

As such, according to some example embodiments, it is possible to provide a method and system for real-time model predictive control-based planning of an autonomous vehicle based on identification and classification learning of constraints.

The systems or the apparatuses described herein may be implemented using hardware components, software components, and/or combination of the hardware components and the software components. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, virtual equipment, computer storage medium or device, to provide instructions or data to the processing device or to be interpreted by the processing device. The software also may be distributed over network coupled computer systems so that the software is stored and executed in a distributed fashion. The software and data may be stored in one or more computer readable storage mediums.

The methods according to the example embodiments may be recorded in non-transitory computer-readable media including program instructions to be performed through various computer methods. The media may include, alone or in combination with the program instructions, data files, data structures, and the like. The media may continuously store a computer-executable program or may temporarily store the same for execution or download. Also, the media may be various recording devices or storage devices in which a single piece of hardware or a plurality of hardware is combined and may be distributed over a network without being limited to media directly connected to a computer system. Examples of the media include magnetic media such as hard disks, floppy disks, and magnetic tapes; optical media such as CD ROM disks and DVDs; magneto-optical media such as floptical disks; and hardware devices that are specially designed to store and perform program instructions, such as read-only memory (ROM), random access memory (RAM), flash memory, and the like. Also, examples of other media may include recording media and storage media managed by an app store that distributes applications or a site, a server, and the like that supplies and distributes other various types of software. Examples of program instructions include both machine code, such as code produced by a compiler, and advanced language code that may be executed by the computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A real-time model predictive control-based planning method of a computer device comprising at least one processor, the method comprising:
generating, by the at least one processor, a class prediction decision value that determines an upper bound and a lower bound of constraints in an optimal control problem through an observation value for a driving environment; and
receiving, by the at least one processor, the class prediction decision value and the observation value from the driving environment and generating a main trajectory.

2. The method of claim 1, wherein the class prediction decision value includes a value for identifying a surrounding object in the driving environment and classifying the same into a plurality of levels including the upper bound and the lower bound to determine whether an ego vehicle gives way to the surrounding object or passes before the surrounding object.

3. The method of claim 2, wherein the upper bound includes an upper bound of longitudinal distance constraints, the lower bound includes a lower bound of longitudinal distance constraints, and the plurality of levels further includes ignore that does not need to be considered for constraints.

4. The method of claim 2, wherein the generating of the class prediction decision value comprises generating the class prediction decision value by identifying and classifying the surrounding object into one of the plurality of levels and by simplifying a problem through convexification of non-convex constraints of model predictive control-based planning into convex constraints.

5. The method of claim 1, wherein the generating of the class prediction decision value comprises generating the class prediction decision value by identifying and classifying a surrounding object in the driving environment using a trained deep learning network, in order to provide a high level decision maker function.

6. The method of claim 5, wherein the deep learning network is trained through deep reinforcement learning based on a state for an ego vehicle and the surrounding object, an action of identifying and classifying a class based on the state, and a reward generated based on results of the action.

7. The method of claim 6, wherein longitudinal constraints of convex nature of model predictive control-based planning are determined through class identification and classification that is the action,
a trajectory is generated based on the longitudinal constraints through the model predictive control-based planning, and
the reward for at least one of success, collision, failure, and driving performance of the generated trajectory is computed through evaluation for the generated trajectory.

8. The method of claim 5, wherein the deep learning network is trained through supervised machine learning using a dataset generated by a search-based model predictive control-based planning, the search-based model predictive control-based planning generating a trajectory using a state transmitted from a simulator for an arbitrary driving environment, generating classification data by identifying and classifying classes of surrounding objects based on the generated trajectory, and storing the classification data in a dataset.

9. The method of claim 8, wherein the search-based model predictive control-based planning combines an A* algorithm with model predictive control-based planning, where the A* algorithm supports MPP(Model Predictive Planning) convergence and enables convexification.

10. The method of claim 8, wherein the deep learning network is trained using the classification data as ground truth.

11. The method of claim 10, wherein the deep learning network is trained through a random batch of the dataset.

12. The method of claim 8, wherein the search-based model predictive control-based planning sets constraints by generating the trajectory and identifying and classifying the surrounding object through a heuristic method.

13. The method of claim 1, wherein the generating of the main trajectory comprises generating the main trajectory using model predictive control-based planning among optimization-based planning methods.

14. The method of claim 1, further comprising:
generating, by the at least one processor, a contingency trajectory through the observation value for the driving environment.

15. The method of claim 14, further comprising:
determining, by the at least one processor, one of the main trajectory and the contingency trajectory as a final trajectory.

16. A non-transitory computer-readable recording medium storing instructions that when executed by a processor, cause the processor to perform a real-time model predictive control-based planning method comprising:
generating a class prediction decision value that determines an upper bound and a lower bound of constraints in an optimal control problem through an observation value for a driving environment; and
receiving the class prediction decision value and the observation value from the driving environment and generating a main trajectory.

17. A computer device comprising:
at least one processor configured to execute computer-readable instructions,
wherein the at least one processor causes the computer device to,
generate a class prediction decision value that determines an upper bound and a lower bound of constraints in an optimal control problem through an observation value for a driving environment, and
receive the class prediction decision value and the observation value from the driving environment and generate a main trajectory.

18. The computer device of claim 17, wherein the class prediction decision value includes a value for identifying a surrounding object in the driving environment and classifying the same into a plurality of levels including the upper bound and the lower bound to determine whether an ego vehicle gives way to the surrounding object or passes before the surrounding object.

19. The computer device of claim 18, wherein, to generate the class prediction decision value, the at least one processor causes the computer device to identify and classify the surrounding object into one of the plurality of levels and to simplify a problem through convexification of non-convex constraints of model predictive control-based planning into convex constraints.

20. The computer device of claim 16, wherein, to generate the class prediction decision value, the at least one processor causes the computer device to generate the class prediction decision value by identifying and classifying a surrounding object in the driving environment using a trained deep learning network, in order to provide a high level decision maker function,
wherein the deep learning network is trained through deep reinforcement learning based on a state for an ego vehicle and the surrounding object, an action of identifying and classifying a class based on the state, and a reward generated based on results of the action, or is trained through supervised machine learning that generates a trajectory through search-based model predictive control-based planning using a state transmitted from a simulator for an arbitrary driving environment, generates classification data by identifying and classifying classes of surrounding objects based on the generated trajectory, and stores the same in a dataset
